(19) United States
(12) Patent Application Publication
(10) Pub. No.: US 2019/0018366 A1
(43) Pub. Date: Jan. 17, 2019

(54) LAMINATED GLASS PANE HAVING A SENSOR ASSEMBLY AND METHOD FOR PRODUCING A LAMINATED GLASS PANE HAVING A SENSOR ASSEMBLY

(71) Applicant: Saint-Gobain Glass France, Courbevoie (FR)

(72) Inventors: Patrick WEBER, ALSDORF (DE); Michael LABROT, AACHEN (DE); Klaus SCHMALBUCH, AACHEN (DE)

(21) Appl. No.: 16/070,258

(22) PCT Filed: Mar. 20, 2017
(86) PCT No.: PCT/EP2017/056478

§ 371 Date: Jul. 13, 2018

(30) Foreign Application Priority Data
May 23, 2016 (EP) 16170773.2

(51) Int. Cl. G03H 1/02; B32B 17/06; B32B 17/10; G03H 1/22; B60R 11/00; E06B 3/66; E06B 5/00; G09F 19/12

(52) U.S. Cl. CPC G03H 1/0252; B32B 17/064; B32B 17/10541; G03H 1/2286; G06F 3/044; E06B 3/6608; E06B 5/00; G09F 19/12; B60R 11/00

(57) ABSTRACT

A laminated glass pane. The laminated glass pane has a sensor assembly. The sensor assembly has a first glass layer and a second glass layer joined by a combination film. The sensor assembly is suitable for detecting an approach of a user's finger. According to one aspect, a hologram is arranged at the location of the sensor assembly, the hologram becoming visible to a viewer upon illumination of the hologram. According to another aspect, the hologram is arranged between the first glass layer and the second glass layer. A method for producing a laminated glass pane having a sensor assembly is also presented.

The invention relates to a laminated glass pane having a sensor assembly and a method for producing a laminated glass pane having a sensor assembly.

### BACKGROUND

It is known that switching regions can be formed by a surface electrode or by an arrangement of two coupled electrodes, for example, as capacitive switching regions. When an object, e.g., a finger, approaches the switching region, the capacitance against ground of the surface electrodes or the capacitance of the capacitor formed by the two coupled electrodes changes. Such switching regions are known, for example, from US 2010/179725 A1, U.S. Pat. No. 6,654,070 B1, WO 2013/091961 A1, and US 2006/275599 A1.

The capacitance change is measured by a circuit arrangement or sensor electronics and when a threshold value is exceeded, a switching signal is triggered. Circuit arrangements for capacitive switches are known, for example, from DE 20 2006 006 192 U1, EP 0 899 882 A1, U.S. Pat. No. 6,452,514 B1, and EP 1 515 211 A1.

From WO 2013/053 61 1 A1, an electrochromic insulating glazing unit with a sensor surface is known.

Also known from DE 35 32 120 A1 is a windshield with a reflecting device for projecting optical information or warning signals into the field of vision of the driver by means of a reflection hologram with mirror properties.

In particular, in the case of transparent or small area sensor surfaces, it can, however, be problematic for a user to be able to recognize the sensor surface as such.

FIG. 1 schematically depicts an exemplary situation in relation to a user B₁ and a user B₂.

Schematically depicted are 2 sensor assemblies S_{touch} that are situated at the upper edge of a laminated glass pane 100. So that these are recognizable, a first marking M₁ is applied relative to the left sensor assembly, which, for example, signals the sensitive region by means of arrows, and a second marking M₂ is applied relative to the right sensor assembly, which, for example, signals the region by means of a circle.

It should be noted that the permanent attachment of markings can be disturbing, in particular, however, when a sensor assembly cannot be used by a person who is not within the reach of the sensor assembly. For example, the left sensor assembly cannot be reached by person B₂, such that the marking restricts the field of vision of the person B₂.

Such situations are disadvantageous, in particular in the case of vehicle panes since, here, specific requirements are made on the field of vision.

Consequently, it would be desirable to be able to provide laminated glass panes with sensor assemblies that make sensor assemblies perceptible in a position-selective manner.

### SUMMARY OF THE INVENTION

The object is accomplished by a laminated glass pane having a sensor assembly, wherein the laminated glass pane has a first glass layer and a second glass layer joined by a combination film, wherein the sensor assembly is suitable for detecting the approach of a finger. A hologram is arranged at the location of the sensor assembly, which hologram becomes visible to a viewer upon illumination, wherein the hologram is arranged between the first glass layer and the second glass layer.

With the assembly according to the invention, a sensor assembly is perceptible in a position-selective manner such that an individual who can also operate the sensor assembly can detect the position of the sensor assembly, whereas for other individuals who cannot operate the sensor assembly, disruptions of the field of vision are reduced.

In another embodiment of the invention, the sensor assembly has a capacitive sensor or an optical sensor.

I.e., by means of the invention, different types of sensors can be identified, enabling a large range of use.

In yet another embodiment of the invention, the hologram is applied on the combination film. With placement on the combination film, production can be simplified and, also, the hologram can be reliably protected against negative production impacts as well as against damage from external forces.

According to another embodiment of the invention, the combination film contains at least one material selected from the group comprising polybutylene terephthalate (PBT), polycarbonate (PC), polyethylene terephthalate (PET) and polyethylene naphthalate (PEN), polyvinyl chloride (PVC), polyvinyl fluoride (PVF), polyvinyl butyral (PVB), ethylene vinyl acetate (EVA), polyacrylate (PA), polymethyl methacrylate (PMMA), polyurethane (PUR), and/or mixtures and copolymers thereof.

I.e., the invention allows versatile adaptation to different optical and mechanical conditions.

According to yet another embodiment of the invention, at least parts of the sensor assembly are applied or introduced as wires on or in the combination film.

With the application or introduction of parts of the sensor assembly on the combination film, production costs can be reduced and the pane thickness can be kept low.

In another embodiment of the invention, the sensor assembly has one planar, transparent, electrically conductive layer or a plurality of planar, transparent, electrically conductive layers that are delimited by insulating separating lines.

According to another embodiment of the invention, the sensor assembly and the hologram are arranged on a common section of the combination film or a carrier within the laminated glass pane.

With common provision on a common section, production costs can be reduced.

In another embodiment, the hologram is designed such that a first view of the hologram appears upon reflective illumination in relation to the viewer.

I.e., the appearance/disappearance of a hologram can be controlled by selective illumination such that, for example, only active sensor assemblies are identifiable as such, whereas inactive sensor assemblies remain concealed. In addition, it is possible, through different illuminations, for example, different angles/different light, to generate the view of different holograms in relation to the viewer.

In another embodiment, the hologram is designed such that a second view of the hologram appears upon transmissive illumination in relation to the viewer.

I.e., through external illumination, the appearance/disappearance of a hologram can be controlled such that, for example, only certain sensor assemblies are identifiable as such, whereas inactive sensor assemblies remain concealed.

According to another embodiment of the invention, a laminated glass pane arrangement according to the invention has a laminated glass pane and an illumination source that controllably illuminates the hologram such that it appears to the user.

According to yet another embodiment of the invention, the laminated glass pane according to the invention can be used in vehicles or buildings or as an information display.

I.e., the range of application is very large such that the laminated glass pane according to the invention can be produced economically.

According to yet another embodiment of the invention, the laminated glass pane according to the invention can be produced in a simple economical method that includes obtaining a hologram, that includes the introduction of the hologram on a combination film of the laminated glass pane, wherein the step of the introduction is selected from laminating and gluing, and includes the completion of the laminated glass pane.

According to yet another embodiment of the invention, the hologram is at least partially transparent.

### SUMMARY OF THE DRAWINGS

Embodiments of the present invention are described by way of example with reference to the appended drawings, which depict:

FIG. 1 a schematic overview of a laminated glass pane having a prior art sensor assembly,

FIG. 2 a schematic overview of a laminated glass pane having a sensor assembly according to embodiments of the invention in relation to a first user position,

FIG. 3 a schematic overview of a laminated glass pane having a sensor assembly according to embodiments of the invention in relation to a second user position,

FIG. 4 a schematic cross-section through a sensor assembly according to one aspect of the invention,

FIG. 5 a schematic overview of a sensor assembly according to one aspect of the invention, and

FIG. 6 a schematic cross-section through a hologram according to one aspect of the invention.

### DETAILED DESCRIPTION OF THE INVENTION WITH REFERENCE TO THE DRAWINGS

In the following, the invention is presented in greater detail with reference to the figures. It should be noted that different aspects are described, which can in each case be used individually or in combination. I.e., any aspect can be used with different embodiments of the invention unless explicitly presented as a pure alternative.

Moreover, in the following, for the sake of simplicity, as a rule reference will always be made to only one entity. Unless explicitly noted, the invention can, however, also have a plurality of the entities in question in any case. Thus, the use of the words “a”, “an”, and “one” are understood to indicate that in a simple embodiment at least one entity is used.

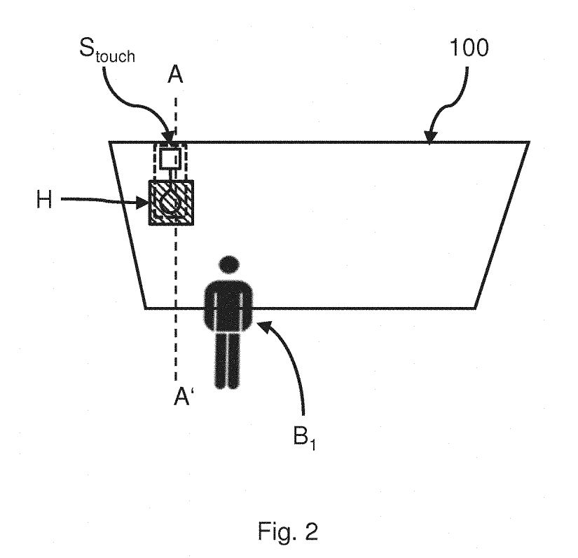

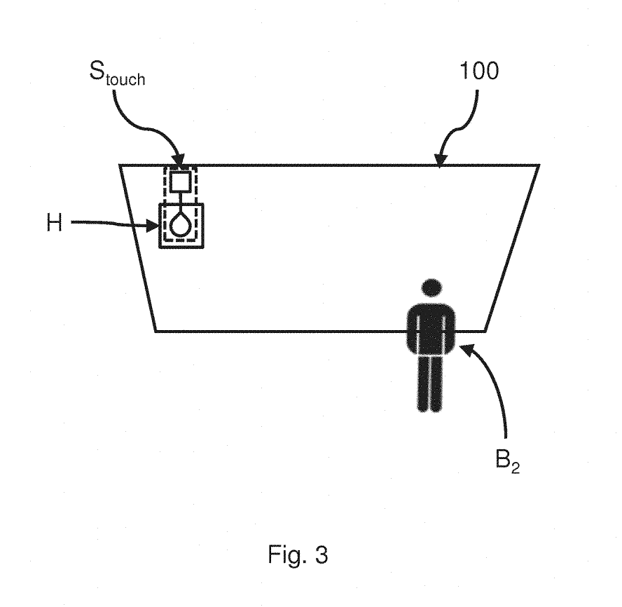

FIG. 2 schematically depicts an exemplary situation according to embodiments of the invention in relation to a user B₁; and FIG. 3, in relation to another individual B₂.

The laminated glass pane 100 according to the invention has one sensor assembly S_{touch} or a plurality of sensor assemblies S_{touch}, wherein the laminated glass pane 100 has a first glass layer GS₁ and a second glass layer GS₂ joined by at least one combination film F or a plurality of combination films F₁, F₂. The sensor assembly/assemblies S_{touch} is/are suitable for detecting the approach of a finger.

The sensor region itself is identified in that a hologram H is arranged at the location of the sensor assembly, which becomes visible to a viewer upon illumination, wherein the hologram H is arranged between the first glass layer GS₁ and the second glass layer GS₂.

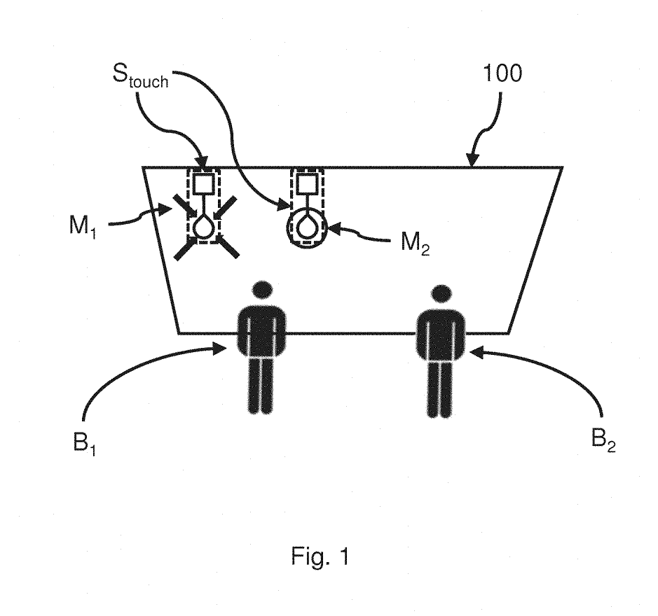

I.e., analogously to FIG. 1, FIG. 2 depicts a sensor assembly S_{touch}, which is situated on the upper edge of a laminated glass pane 100. In order for this sensor assembly S_{touch} to become identifiable, a hologram H is provided in relation to the sensor assembly.

To the user B₁, the hologram H can appear similar to the markings M₁ and M₂. In contrast, the hologram H is designed such that for individual B₂, who is not within reach of the sensor assembly S_{touch} and cannot operate the sensor assembly S_{touch}, it is partially transparent or even invisible. I.e., the hologram H does not restrict the field of vision of the individual B₂.

Such a situation is advantageous in particular with vehicle panes since, here, specific requirements are imposed on the field of vision. Thus, for example, the sensor assembly S_{touch} can be visible only for the driver B₁, e.g., for the switching of specific vehicle elements, whereas the front-seat passenger B₂ cannot see the corresponding markings in the form of the hologram H. Conversely, it can, however, also be advantageous with the suitable installation of a sensor surface S_{touch} within reach of the front-seat passenger B₂—e.g., for controlling air conditioning/window/multimedia system—for this to be visible only for the front seat passenger B₂, whereas it remains partially transparent or even invisible for the driver, and his field of vision is thus not limited.

I.e., by means of the hologram H, it is possible to provide position-selective markings, e.g., for identification of sensor assemblies. This utilizes the fact that a user of a sensor assembly is situated in a specific angular region relative to the laminated glass pane 100, whereas another viewer who is situated outside the range of the sensor assembly assumes a different angle relative to the sensor region.

The laminated glass pane 100 according to the invention is not limited to a specific sensor technology. Instead, the sensor assembly S_{touch} can be used along with a wide variety of sensor technologies. For example, the sensor assembly has a capacitive sensor or an optical sensor. The sensor assembly/assemblies S_{touch} is/are, for example, suitable for detecting the approach of a finger. The approach can be detected, for example, in the case of a capacitive sensor by a change in the charge on a capacitor. In the case of an optical sensor, the detection is, for example, possible based on a shadow using a light-sensitive resistor or a photoelectric cell, or even by means of a camera outside the laminated glass pane 100 that observes the sensor assembly. Of course, not only the approach but also the direct placement of a finger on the sensor region can be detected.

In the following description, capacitive sensors for detecting the approach will be described in particular. The invention is, however, not restricted thereto.

In one embodiment of the invention, the hologram H is applied on the combination film F; F₁, F₂.

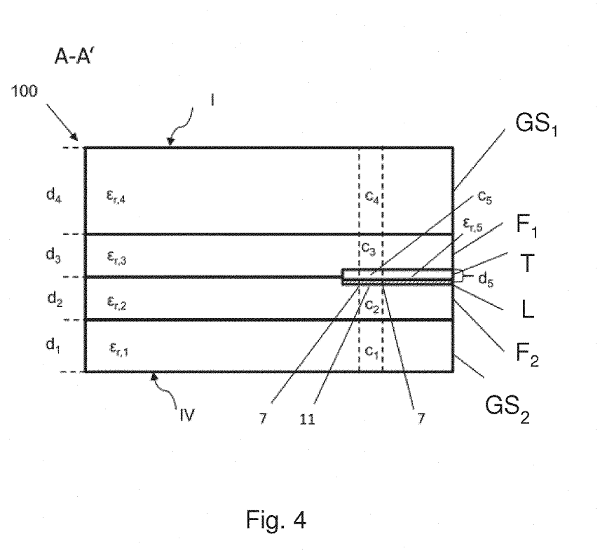

FIG. 4 depicts an exemplary section through a laminated glass pane 100 along the line A-A′ in FIG. 2.

There, by way of example, two combination films F₁ and F₂ are situated between a glass pane GS₁ and a glass pane GS₂. Here, for example, the hologram can be applied on one of the films F₁ or F₂ at a suitable location, or, on the other hand, a carrier T is introduced into a cutout of the combination film F₁, F₂ or—as depicted—introduced between the combination film F₁, F₂. The section in FIG. 4 is to be understood only by way of example and additional layers can be provided between the glass pane GS₁ and a glass pane GS₂.

The glass pane GS₁ and/or the glass pane GS₂ preferably contain glass, particularly preferably flat glass, float glass, quartz glass, borosilicate glass, soda lime glass, or clear plastics, preferably rigid clear plastics, in particular polyethylene, polypropylene, polycarbonate, polymethyl methacrylate, polystyrene, polyamide, polyesters, polyvinyl chloride, and/or mixtures thereof.

The glass pane GS₁ and/or the glass pane GS₂ are preferably transparent, in particular for the use of the laminated glass pane 100 as a windshield or a rear window of a vehicle or other uses in which high light transmittance is desired. In the context of the invention, “transparent” then means a laminated glass pane 100 that has transmittance greater than 70% in the visible spectral range. For laminated glass panes 100 that are not within the driver's traffic-relevant field of vision, for example, for roof panels, the transmittance can, however, even be much less, for example, greater than 5%.

The thickness of the glass pane GS₁ and/or glass pane GS₂ can vary widely and thus be ideally suited to the requirements of the individual case. Preferably used are standard thicknesses from 0.1 mm to 25 mm, preferably from 1.4 mm to 2.5 mm for vehicle glass and preferably from 4 mm to 25 mm for furniture, appliances, and buildings, in particular for electric heaters. The size of the laminated glass pane 100 can vary widely and is governed by the size of the use according to the invention. The substrate and, optionally, the cover pane have, for example, in the automotive sector and in architecture usual areas from 200 cm² up to 20 m².

The laminated glass pane 100 can have any three-dimensional shape. Preferably, the three-dimensional shape has no shadow zone such that it can, for example, be coated by cathodic sputtering. Preferably, the substrates are planar or slightly or highly curved in one or more spatial directions. In particular, planar glass panes GS₁ and GS₂ are used. The glass pane GS₁ and/or GS₂ can be colorless or colored.

The glass pane GS₁ and/or the glass pane GS₂ preferably have relative permittivity ε_{r,1/4} from 2 to 8 and particularly preferably from 6 to 8. With such relative permittivities, it was possible to obtain a particularly good distinction between contacting the contact surface via the outside surface of the substrate compared to the outside surface of the cover pane.

It is particularly advantageous for the combination film F; F₁, F₂ to contain at least one material selected from the group comprising polybutylene terephthalate (PBT), polycarbonate (PC), polyethylene terephthalate (PET) and polyethylene naphthalate (PEN), polyvinyl chloride (PVC), polyvinyl fluoride (PVF), polyvinyl butyral (PVB), ethylene vinyl acetate (EVA), polypropylene (PP), polyvinyl chloride (PVC), polyacrylate (PA), polymethyl methacrylate (PMMA), polyurethane (PUR), polyacetate resin, casting resins, acrylates, fluorinated ethylene propylenes, polyvinyl fluoride, and/or ethylene tetrafluoroethylene and/or mixtures and copolymers thereof. The combination film F; F₁, F₂ is preferably transparent.

The intermediate layer between the first glass pane GS₁ and the second glass pane GS₂ can be formed by one or even a plurality of combination films F; F₁, F₂ arranged one atop another, wherein the thickness of a combination film F; F₁, F₂ is preferably from 0.025 mm to 1 mm, typically 0.38 mm or 0.76 mm. The intermediate layers can preferably be thermoplastic and, after lamination, bond the glass pane GS₁, the glass pane GS₂, and any other intermediate layers to one another. The intermediate layer preferably has relative permittivity of 2 to 4 and particularly preferably of 2.1 to 2.9. With such relative permittivities, it was possible to obtain a particularly good distinction between contacting the contact surface via the outside surface of the glass pane GS₂ compared to the outside surface of the glass pane GS₁.

The carrier T is preferably a transparent film. The carrier T preferably contains or is made of a polyethylene terephthalate (PET) film. The thickness of the carrier T is preferably from 0.025 mm to 0.1 mm. the carrier preferably has relative permittivity of 2 to 4 and particularly preferably of 2.7 to 3.3. With such a carrier T, particularly good laminated glass panes 100 can be produced since such thin carriers T can be integrated well and optically inconspicuously in the laminated glass pane 100, even with only section-wise arrangement. At the same time, good and selective switching signals can be generated.

It is furthermore advantageous when, for example, parts of the sensor assembly S_{touch} are applied or introduced as wires on or in the combination film F; F₁, F₂ or on the carrier T.

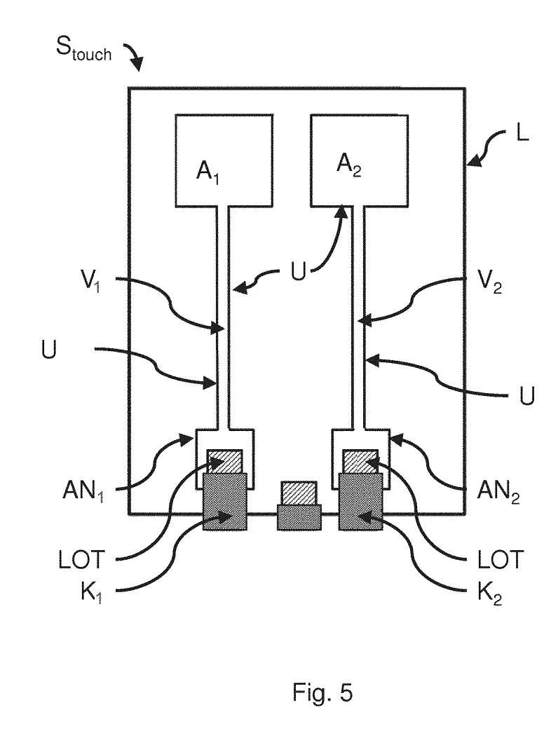

We will explain this in the following using the example of a capacitive sensor with reference to FIGS. 4 and 5.

By way of example, an electrically conductive layer L can be arranged on the carrier T. The electrically conductive layer L preferably includes a transparent, electrically conductive coating. Here, “transparent” means permeable to electromagnetic radiation, preferably electromagnetic radiation of a wavelength from 300 nm to 1300 nm, and in particular to visible light.

Electrically conductive layers L according to the invention are known, for example, from DE 20 2008 017 611 U1, EP 0 847 965 B1, or WO2012/052315 A1. Typically, they include one or a plurality, for example, two, three, or four electrically conductive, functional layers. The functional layers preferably include at least one metal, for example, silver, gold, copper, nickel, and/or chromium, or a metal alloy. The functional layers particularly preferably include at least 90 wt.-% of the metal, in particular at least 99.9 wt.-% of the metal. The functional layers can be made of the metal or the metal alloy. The functional layers particularly preferably include silver or a silver-containing alloy. Such functional layers have particularly advantageous electrical conductivity with, at the same time, high transmittance in the visible spectral range. The thickness of a functional layer is preferably from 5 nm to 50 nm, particularly preferably from 8 nm to 25 nm. In this range for the thickness of the functional layer, advantageously high transmittance in the visible spectral range and particularly advantageous electrical conductivity are obtained.

Typically, at least one dielectric layer is arranged in each case between two adjacent functional layers. Preferably, another dielectric layer is arranged below the first and/or above the last functional layer. A dielectric layer includes at least one individual layer made of a dielectric material, for example, containing a nitride such as silicon nitride or an oxide such as aluminum oxide. However, the dielectric layer can also comprise a plurality of individual layers, for example, individual layers made of a dielectric material, smoothing layers, matching layers, blocker layers, and/or antireflection layers. The thickness of a dielectric layer is, for example, from 10 mm to 200 nm.

This layer structure is generally obtained by a sequence of deposition operations that are carried out by a vacuum method such as magnetron-assisted cathodic sputtering.

Other suitable electrically conductive layers L preferably include indium tin oxide (ITO), fluorine-doped tin oxide (SnO₂:F), or aluminum-doped zinc oxide (ZnO:Al).

The electrically conductive layer L can, in principle, be any coating that can be contacted electrically. If the laminated glass pane 100 according to the invention is intended to allow through-vision, as is the case, for example, with panes in the window sector, the electrically conductive layer L is preferably transparent. In an advantageous embodiment, the electrically conductive layer L is a layer or a layer structure of multiple individual layers having a total thickness less than or equal to 2 μm, particularly preferably less than or equal to 1 μm.

In the exemplary embodiment depicted, the structure and tuning of the sensor electronics system are coordinated such that when the outer pane surface IV of the glass pane GS₁ is contacted via the contact region 11 of the capacitive switching region, a switching signal is triggered, whereas when the outer pane surface I of the glass pane GS₂ is contacted via the capacitive switching region, no switching signal is triggered. To this end, the thicknesses and the materials of the laminated pane 100 according to the invention are selected according to the invention such that the surface capacitance c_{I} between the contact region 11 and the outer surface IV of the glass pane GS₁ is greater than the surface capacitance c_{A} between the contact region 11 and the outer surface I of the glass pane GS₂.

The surface capacitance c_{I} or c_{A} is, in the context of the present invention, defined as the capacitance of a plate capacitor of that region of the laminated glass pane 100, which results from orthogonal projection of the contact region 11 between the contact region 11 and the outer surface IV of the glass pane GS₁ or the outer surface I of the glass pane GS₂, with the resultant capacitance normalized over the area of the contact region.

In the example depicted in detail in FIG. 4, the surface capacitance c_{I} between the contact region 11 and the outer surface IV of the glass pane GS₁ results as the serial connection of the individual capacitances

$$\frac{1}{{c}_{I}} = \frac{1}{{c}_{1}} + \frac{1}{{c}_{2}} ,$$

with the individual capacitance at ci=ε₀*ε_{r,i}/dᵢ. This corresponds to the capacitance Cᵢ of the respective individual layer with relative permittivity ε_{r,i} and thickness dᵢ, normalized over the area A of the contact region 11, i.e., cᵢ=Cᵢ/A. Analogous to this, the surface capacitance c_{A} between the contact region 11 and the outer surface I of the cover pane 4 results as the serial connection of the individual capacitance

$$\frac{1}{{c}_{A}} = \frac{1}{{c}_{3}} + \frac{1}{{c}_{4}} .$$

Moreover, the laminated glass pane can also have a low-E coating on the inner surface IV of the laminated glass pane 100, whereby at least one capacitive switching region is electrically separated out of the low-E coating by at least one coating-free separating line U.

The term “outer surface” of the laminated glass pane 100 means, in the case of a vehicle glazing/architectural pane/structural glazing, the surface of the pane that points outward, i.e., away from the (vehicle) interior. Accordingly, “inner surface” means the surface of the laminated glass pane 100 that points toward the (vehicle) interior.

This low-E coating includes at least one functional layer and, optionally, in each case, one or a plurality of bonding layers, barrier layers, and/or antireflection layers. The low-E coating is preferably a layer system made up, in each case, of at least one bonding layer, one functional layer, one barrier layer, one antireflection layer, and another barrier layer.

Particularly suitable low-E coatings contain a functional layer made of at least one electrically conductive oxide (TCO), preferably indium tin oxide (ITO), fluorine-doped tin oxide (SnO₂:F), antimony-doped tin oxide (SnO₂:Sb), aluminum-doped zinc oxide (ZnO:Al), and/or gallium-doped zinc oxide (ZnO:Ga).

Particularly advantageous low-E coatings have interior-side emissivity of the laminated glass pane 100 according to the invention less than or equal to 60%, preferably less than or equal to 45%, particularly preferably less than or equal to 30%, and, in particular, less than or equal to 20%. Here, the term “interior-side emissivity” refers to the measurement that indicates how much thermal radiation the pane gives off in the installed position compared to an ideal thermal radiator (a black body) in an interior, for example, of a building or of a vehicle. The term “emissivity” means the total normal emissivity at 283 K pursuant to the standard EN 12898.

In an advantageous embodiment, the sheet resistance of such an exemplary low-E coating is from 10 ohm/square to 200 ohm/square and preferably from 10 ohm/square to 100 ohm/square, particularly preferably from 15 ohm/square to 50 ohm/square, and in particular from 20 ohm/square to 35 ohm/square.

The absorption of the low-E coating in the visible spectral range is preferably approx. 1% to approx. 15%, particularly preferably approx. 1% to approx. 7%. The absorption of the coating can be determined by measuring the absorption of a coated pane and subtracting the absorption of the uncoated pane. The pane preferably has, in reflection, a color value a* of −15 to +5 and a color value b*of −15 to +5, observed from the side provided with the low-E coating according to the invention. The data a* and b* are based on the color coordinates of the colorimetric model (L*a*b*-color space).

An advantageous low-E coating has, in the visible spectral range, low absorption and low reflection and, consequently, high transmittance. The low-E coating can, consequently, also be used on panes for which a significant reduction of transmittance is undesirable, for example, for window panes in buildings, or banned by law, for example, for windshields or front side panes in motor vehicles.

Another advantageous transparent electrically conductive layer L can also have a sheet resistance of 0.4 ohm/square up to 200 ohm/square. In a particularly preferred embodiment, the electrically conductive layer according to the invention has a sheet resistance of 0.5 ohm/square to 20 ohm/square.

Coatings with such sheet resistances are suitable, among other things, for heating vehicle panes with typical on-board voltages of 12 V to 48 V or in electric vehicles with typical on-board voltages of up to 500 V.

Transparent, electrically conductive layers L can, for example, be heated electrically, can have IR reflecting properties or low-E properties.

In one embodiment of the invention, the sensor assembly S_{touch} has at least one planar, transparent, electrically conductive layer L, which is delimited by insulating separating lines U.

This is depicted in FIG. 5 by way of example. There, on a carrier T that has an electrically conductive coating L, a corresponding capacitive sensor is formed. It has two relatively large areas A₁ and A₂ that are arranged at the upper edge shown. The areas are connected via connections V₁ and V₂ to exemplary connectors AN₁ and AN₂. The connectors AN₁ and AN₁ are connected to an exemplary sensor evaluation electronics system via two ribbon connectors K₁ and K₂ mounted using solder LOT. Other forms of sensor structure, in particular wireless sensors are explicitly not ruled out. By means of the patterning U, which can, for example, be produced by masking during the coating process or by removal after coating, lines and capacitance plates can now be formed similar to the creation of printed circuit boards. By way of example, the plate A₂ and the connections V₂ and the connector A₂ are formed, e.g., by means of the separating line U, from the electrically conductive layer L. The plate A₁ and the connections V₁ and the connector A₁ are formed by means of another separating line U from the electrically conductive layer L. These separating line(s) U can be patterned, e.g., by laser (ablation).

It is readily possible to arrange both parts of the sensor assembly S_{touch} and the hologram H on a common section of the combination film F; F₁, F₂ or on a carrier T within the laminated glass pane 100.

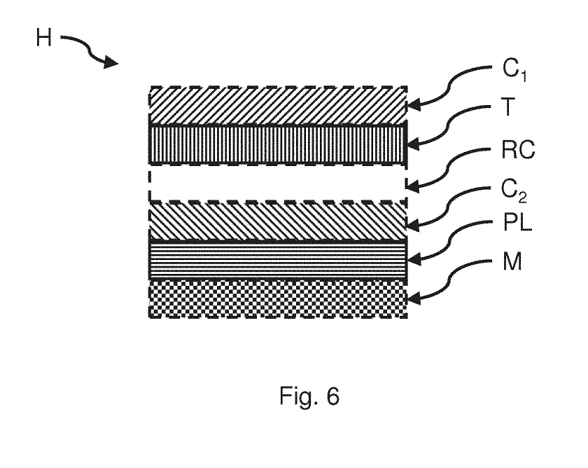

In this regard, briefly explained in the following with reference to FIG. 6 is the typical structure of conventional holograms H, which are used, for example, for product security (origin identifier, etc.), and which can also be used in laminated glass panes 100 according to the invention.

Typically, a holographic structure (having a different thickness profile and/or refractive index profile) is produced by (hot) stamping of, for example, an embossable coating on an exemplary PET film of, for example, a thickness of 19 mm to 50 mm.

Obviously, this PET film can also serve at the same time as carrier T for electrical layers L of the sensor assembly S_{touch}.

Typically, such a PET film has tensile strength of approx. 24 kgf/mm², with elongation at break 120%-150% and heat shrinkage at 150°/30 min 1% or less. Typically, such PET films have hazing of 1% with transmittance of 90%.

Such a carrier T can, for example, be coated with a highly reflective metallization M, wherein other layers can also be provided for application. The metallization M can, for example, be produced based on ZnS, which has a refractive index of 2.3 to 2.4 with 35% reflectance.

A coating C₁ can be situated, as needed, on the side away from the viewer. This coating C₁ can, for example, permit printing with non-holographic elements.

A separating layer RC can be situated, as needed, on the side facing the viewer. Furthermore, a second coating C₂ can optionally be provided, which carries, for example, the embossable coating PL.

In the previous presentation, the nature of the hologram H was deliberately not discussed.

It is essential for the hologram to be sensitive to the position of a viewer. I.e., the hologram H is designed such that is illuminated either by ambient light and/or selective illumination, whether by lighting integrated into the pane/sensor assembly by means of suitable (organic) light emitting diodes (p)LEDs, whether by a light source arranged outside the laminated glass pane 100, such that the user of the sensor assembly S_{touch} can locate the sensor assembly.

I.e., the hologram H can, for example, be designed such that a first view of the hologram H appears upon reflective illumination in relation to the viewer.

I.e., the appearance/disappearance of a hologram can be controlled by selective illumination, such that, for example, only active sensor assemblies as such are detectable, whereas inactive sensor assemblies remain hidden. In addition, it is possible to produce the view of different holograms in relation to the viewer via different illuminations, e.g., different angles/different light relative to the laminated glass pane 100, or stamping of the hologram H.

Alternatively or additionally, provision can, however, also be made for a second view of the hologram H to appear upon transmissive illumination in relation to the viewer.

I.e., by means of external illumination, the appearance/disappearance of hologram can be controlled such that, for example, only certain sensor assemblies are detectable as such, whereas inactive sensor assemblies remain hidden.

In particular, the hologram H can also be designed such that it is visible only in dark surroundings with corresponding illumination.

Thus, the hologram H can even have multiple superimposed views which arrive depending on the illumination (e.g., on the angle of the illumination) for display relative to the user in particular, the invention, consequently, also proposes a laminated glass pane arrangement that has a laminated glass pane 100 and an illumination source, wherein the illumination source controllably illuminates the hologram H such that it appears to the user.

The illumination source preferably has an LED or an OLED. The particular advantage resides in the small dimensions and the low power consumption. The wavelength range emitted by the illumination source can be freely selected in the range of visible light, for example, based on practical and/or aesthetic considerations. The light irradiation means can include optical elements, in particular for deflecting the light, preferably a reflector and/or an optical waveguide, for example, a glass fiber or a polymeric optical fiber. The illumination source can be arranged at any location of (/relative to) the glass pane GS₁ or glass pane GS₂, in particular on the side edge of the glass pane GS₁ or of the glass pane GS₂ or in a small recess in the middle of the glass pane GS₁ or of the glass pane GS₂.

The light deflecting means preferably has particles, dot grids, stickers, deposits, notches, incisions, line grids, imprints, and/or screen prints and and is suitable for decoupling the light transported in the glass pane GS₁ or the glass pane GS₂ therefrom.

The light deflecting means can be arranged at any position on the level of the glass pane GS₁ or the glass pane GS₂. It is particularly advantageous for the light deflecting means to be arranged in the region of or in the immediate vicinity of the contact region and thus enables rapid finding of the otherwise hardly visible contact region of the sensor assembly S_{touch}. This is particularly advantageous at night or in darkness.

Alternatively, light can be routed to the contact region of the sensor assembly S_{touch} by a light guide that is arranged on the glass pane GS₁ or the glass pane GS₂, or an intermediate layer (e.g., of the combination film F; F₁, F₂) and can mark the contact region.

Alternatively or in combination, the light irradiation means together with the light deflecting means can visualize information on the window pane, for example, report or display the switching state of the capacitive switching region, whether, for example, an electrical function is switched on or switched off.

According to yet another embodiment of the invention, the laminated glass pane 100 according to the invention can be used in vehicles or buildings or as an information display.

I.e., the range of applications is very wide such that the laminated glass pane 100 according to the invention can be produced economically.

In an exemplary method for producing a laminated glass pane 100, a hologram H is first obtained. This hologram H can be a component of the sensor assembly S_{touch} or, however, be a standalone hologram H (e.g., on a carrier T). The hologram H obtained is introduced into a precursor of the laminated glass pane 100, wherein the step of introduction is selected from among lamination, gluing, placement. After introduction and any other intermediate steps relative to the sensor assembly, the laminated glass pane 100 is completed.

Through the use of holograms H, the sensor assembly S_{touch} is displayed position sensitively. Thus, it is a feature of the invention that a user is situated at a typical distance (approx. 60 cm) in front of the laminated glass pane 100 such that he is capable of using the sensor of the sensor assembly S_{touch}. The hologram H is designed such that it is readily detectable with appropriate light incidence at substantially this distance and with viewing from a specific angle, whereas for a “viewer” from different distances and/or angle ranges, it is partially transparent or even completely invisible.

Whereas, during the day, ambient light usually suffices for making a hologram H visible for the viewer; it can be necessary, in the dark, to provide for external illumination such that the hologram H is again visible. This illumination source can, in turn, be appropriately placed, e.g., in a vehicle, it can be arranged on the roof liner, the instrument panel, or A-pillar, in a rearview mirror bracket, etc., such that the light of the illumination source does not bother the viewer B₁.

A further advantage of holograms H is that these holograms cannot be seen on the side facing away from the user. For example, a sensor assembly S_{touch} and the hologram H are arranged for this such that they can be seen on the inside of a vehicle. In contrast, the hologram H cannot be seen on the outside. Thus, the location of the sensor assembly S_{touch} cannot or cannot easily be found such that improper operation from the outside is impeded.

In addition, further functionality can also be provided using the hologram H. Thus, it is also possible to display the manufacturing company and/or to provide a certificate of authenticity. This is frequently advantageous in the case of safety critical elements.

1.-13. (canceled)

14. A laminated glass pane having a sensor assembly, the laminated glass pane comprising:
a first glass layer; and
a second glass layer,
wherein the first glass layer and the second glass layer are joined by a combination film,
wherein a sensor assembly is provided for detecting an approach of a user's finger,
wherein a hologram is arranged at a location of the sensor assembly, the hologram becoming visible to a user upon illumination of the hologram, and
wherein the hologram is arranged between the first glass layer and the second glass layer.

15. The laminated glass pane according to claim 14, wherein the sensor assembly has a capacitive sensor or an optical sensor.

16. The laminated glass pane according to claim 14, wherein the hologram is applied on the combination film.

17. The laminated glass pane according to claim 14, wherein the combination film comprises one or more material selected from the group consisting of polybutylene terephthalate, polycarbonate, polyethylene terephthalate and polyethylene naphthalate, polyvinyl chloride, polyvinyl fluoride, polyvinyl butyral, ethylene vinyl acetate, polyacrylate, polymethyl methacrylate, polyurethane, and/or copolymers, or mixtures thereof.

18. The laminated glass pane according to claim 14, wherein parts of the sensor assembly are applied or introduced as wires on or in the combination film.

19. The laminated glass pane according to claim 14, wherein the sensor assembly comprises a planar, transparent, electrically conductive layer, wherein the the planar, transparent, electrically conductive layer is delimited by plurality of insulating separating lines.

20. The laminated glass pane according to claim 14, wherein parts of the sensor assembly and the hologram are arranged on a common section of the combination film or a carrier within the laminated glass pane.

21. The laminated glass pane according to claim 14, wherein a first view of the hologram appears upon reflective illumination in relation to the user.

22. The laminated glass pane according to claim 14, wherein a second view of the hologram appears upon transmissive illumination in relation to the user.

23. A laminated glass pane arrangement, comprising:
a laminated glass pane according to claim 14; and
an illumination source,
wherein the illumination source controllably illuminates a hologram in the laminated glass pane such that the hologram appears to the user.

24. A method of using of a laminated glass pane, comprising:
providing a laminated glass pane according to claim 14; and
using the laminated glass pane in vehicles or buildings as an information display.

25. A method for producing a laminated glass pane, comprising:
obtaining a hologram; and
introducing the hologram on a combination film of a laminated glass pane; and
completing the laminated glass pane,
wherein introducing the hologram is selected from laminating or gluing the hologram on the combination film.

26. The method for producing a laminated glass pane according to claim 25, wherein the hologram is at least partially transparent.
